(19) United States
(12) Patent Application Publication
(10) Pub. No.: US 2010/0230332 A1
(43) Pub. Date: Sep. 16, 2010

(54) ADSORPTION APPARATUS FOR WASTEWATER

(76) Inventors: Masahiko TSUTSUMI, Fuchu-shi (JP); Shinobu Moniwa, Kawasaki-shi (JP); Katsuya Yamamoto, Kawasaki-shi (JP); Nobuyuki Ashikaga, Kawasaki-shi (JP); Satomi Ebihara, Tokyo (JP); Hidetake Shiire, Tokyo (JP); Kazuhiko Noda, Hino-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/695,950

(22) Filed: Jan. 28, 2010

(30) Foreign Application Priority Data
Mar. 13, 2009 (JP) 2009-060935

(51) Int. Cl. B01D 15/00; B01D 24/40

(52) U.S. Cl. 210/108; 210/117

(57) ABSTRACT

An adsorption apparatus for wastewater, having a reaction tank configured to allow adsorption of a resource substance contained in wastewater on an adsorbent to be carried out therein, a supplying device configured to supply wastewater containing the resource substance to the reaction tank, a charging device configured to charge the adsorbent into the reaction tank, a water discharging device configured to discharge a treated water, obtained after the wastewater is removed of the resource substance by the adsorption, from the reaction tank, a adsorbent discharging device configured to discharge the adsorbent having the resource substance adsorbed thereon, from the reaction tank, and an adsorbent flow out preventing device configured to prevent flow out of the adsorbent from the reaction tank during the adsorption.

### CROSS-REFERENCE TO RELATED APPLICATIONS

This application is based upon and claims the benefit of priority from prior Japanese Patent Application No. 2009-060935, filed Mar. 13, 2009, the entire contents of which are incorporated herein by reference.

### BACKGROUND OF THE INVENTION

1. Field of the Invention

The present invention relates to an adsorption apparatus for wastewater which is configured to adsorb an resource substance such as phosphorus, boron, fluorine, or oil contained in wastewater with the use of an adsorbent.

2. Description of the Related Art

An resource substance, such as phosphorus, contained in wastewater is conventionally treated by adsorption using an adsorbent such as hydrotalcite, a flocculating agent (e.g., aluminum sulfate, PAC (polyaluminum chloride)), or activated carbon. Among these adsorbents, various conventional techniques for treating phosphorus as an adsorbate using hydrotalcite as an adsorbent have been disclosed in, for example, Jpn. Pat. Appln. KOKAI Publication Nos. 2003-299948 (Document 1), 2007-106620 (Document 2), and 2005-60164 (Document 3). Hereinbelow, these conventional techniques disclosed in Documents 1 to 3 will be described with reference to FIGS. 1 to 3.

As shown in FIG. 1, an adsorbent 103 disclosed in Document 1 contains a zeolite particle 33 as a core material, polylactic acid 32 as a binder, and hydrotalcite 31 as a surface coating. The zeolite particle 33 is located innermost and the hydrotalcite 31 is located outermost, and the zeolite particle 33 and the hydrotalcite 31 are bonded together by the binder 32 located therebetween. As shown in FIG. 2, in the case of a conventional unit 100, wastewater is introduced into a bottom part of a reaction tank 102 through a water piping line L1, allowed to flow upwardly so as to come into contact with the adsorbent 103 contained in the reaction tank 102, and then discharged from the reaction tank 102 through an upper discharge line L2 including a valve 104. The adsorbent 103 is supported by a supporter 106, which is provided slightly above a position at which wastewater is introduced into the reaction tank 102. Further, a recovery line L3 to recover the adsorbent 103 from the reaction tank 102 is connected to the reaction tank 102.

By bringing wastewater supplied to the conventional unit 100 into contact with the adsorbent 103 whose surface is coated with the hydrotalcite 31, phosphate anions 34 contained in the wastewater are adsorbed to the adsorbent 103. As shown in FIG. 3, the adsorbent 103 having the phosphate anions 34 adsorbed to the surface thereof composed of the hydrotalcite 31 is taken out of the reaction tank 102 as a spent adsorbent 103A by opening a valve 105 included in the recovery line L3.

However, the above-described conventional techniques have the following problems (1) to (3).

(1) The phosphate anions content in the adsorbent having phosphate anions adsorbed thereto as a resource substance is low, and therefore the purity of the phosphate anions is reduced.

The adsorbent 103 disclosed in Document 1 contains components other than the hydrotalcite 31 such as the binder 32 and the core material 33 in large amounts, and therefore the concentration of phosphate anions in the spent adsorbent 103 is low. This reduces the purity of the phosphate anions, thereby causing problem that when recovered phosphoric acid is used for producing, for example, a fertilizer, the production cost thereof increases.

(2) The influence on the environment is large.

As described above, the adsorbent 103 disclosed in Document 1 contains the binder 32 and the core material 33 in large amounts. In a case where the adsorbent 103 is used as a fertilizer in a small amount, the binder 32 and the core material 33 may not have a negative influence on soil, but in a case where the adsorbent 103 is used as a fertilizer in a large amount, there is a fear that large amounts of the binder 32 and the core material 33 are accumulated in soil and then have a negative influence on the soil. More specifically, zeolite constituting the core material 33 of the adsorbent 103 is like a kind of sand, and therefore when the adsorbent 103 is used as a fertilizer, there is a fear that soil is changed not to one containing phosphoric acid but to one containing a large amount of sand. Therefore, there is a concern that such a fertilizer has a negative influence on the cultivation environment of plants or foods instead of improving it.

(3) Hydrotalcite as the adsorbent flow outs from the reaction tank.

It is considered that the hydrotalcite 31 may be used singly as an adsorbent not containing the binder 32 or the core material 33. However, as described in Documents 2 and 3, since the hydrotalcite 31 is in the form of very fine particles having a particle size of 0.1 to 1 μm (Document 2) or 1 to 20 μm (Document 3), there is a problem that, depending on the flow rate of wastewater, particles of the hydrotalcite 31 flow out from the reaction tank 102 through the discharge line L2 together with treated water (loss of hydrotalcite particles), and therefore the hydrotalcite 31 as an adsorbent disappears from the reaction tank 102 so that adsorption reaction will not occur. In addition, there is also a problem that the hydrotalcite 31 having phosphate anions adsorbed thereto cannot be recovered as a spent adsorbent.

### BRIEF SUMMARY OF THE INVENTION

It is therefore an object of the present invention to provide a wastewater adsorption apparatus capable of effectively preventing a loss of adsorbent from a reaction tank. It is therefore another object of the present invention to provide a wastewater adsorption apparatus capable of effectively increasing the purity of a resource substance contained in the reaction tank.

The present inventors have intensively studied the behavior of the adsorbent in the reaction tank, and as a result, have found that both the above-described problems (1) and (2) associated with the recovery of a spent adsorbent can be solved by using the hydrotalcite 31 as an adsorbent containing no carriers such as the binder 32 and the core material 33. As described above, the hydrotalcite 31 is in the form of fine particles, and is therefore likely to flow out from the reaction tank together with treated water, which makes it difficult for the conventional unit to maintain its initial treatment performance. Therefore, the present inventors have intensively studied the stream of water in the reaction tank, particularly, the movement of water in the reaction tank containing the adsorbent fluidized-bed layer, and based on the results obtained, have examined the effect of some adsorbent flow out preventing means likely to be effective in preventing the flow out of the adsorbent. As a result, the present inventors have found that providing such an adsorbent flow out preventing means in the reaction tank is very effective in solving the above-described problem (3). The present invention is based on these findings, and has the following features.

An adsorption apparatus for wastewater according to the present invention comprises: a reaction tank configured to perform fluid contact reaction between an adsorbent and a resource substance contained in wastewater; a supplying device configured to supply wastewater containing the resource substance to the reaction tank; a charging device configured to charge the adsorbent into the reaction tank; a water discharging device configured to discharge a treated water, obtained by adsorbing the resource substance to the adsorbent, from the reaction tank; a adsorbent discharging device configured to discharge the adsorbent, having the resource substance adsorbed thereto, from the reaction tank; and an adsorbent flow out preventing device configured to prevent flow out of the adsorbent from the reaction tank during fluid contact reaction between the adsorbent and the resource substance contained in the wastewater.

### BRIEF DESCRIPTION OF THE SEVERAL VIEWS OF THE DRAWING

FIG. 1 is a schematic sectional view of a conventional adsorbent;

FIG. 2 is a schematic block diagram showing the structure of a conventional apparatus;

FIG. 3 is a schematic sectional view of the conventional adsorbent having a recovered substance adsorbed thereto;

FIG. 4 is a block diagram showing the structure of an adsorption apparatus for wastewater according to an embodiment of the present invention;

FIG. 5 is a block diagram showing the structure of an adsorption apparatus for wastewater according to another embodiment of the present invention;

FIG. 6 is a block diagram showing the structure of an adsorption apparatus for wastewater according to another embodiment of the present invention;

FIG. 7 is a block diagram showing the structure of an adsorption apparatus for wastewater according to another embodiment of the present invention; and

FIG. 8 is a block diagram showing the structure of an adsorption apparatus for wastewater according to another embodiment of the present invention.

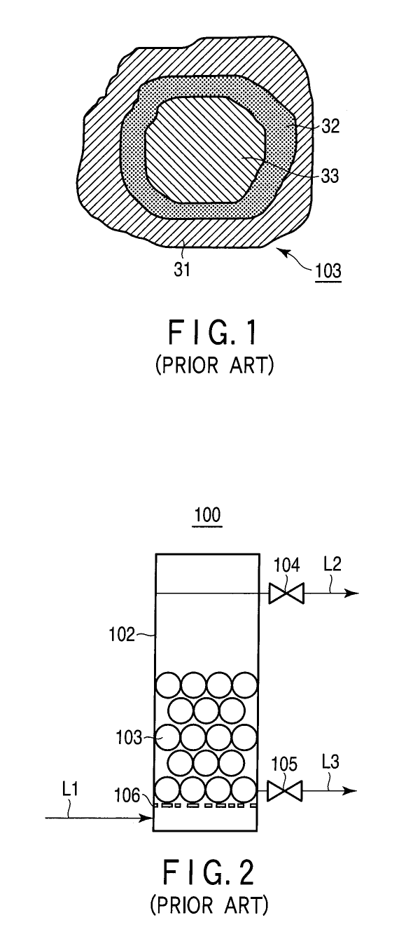

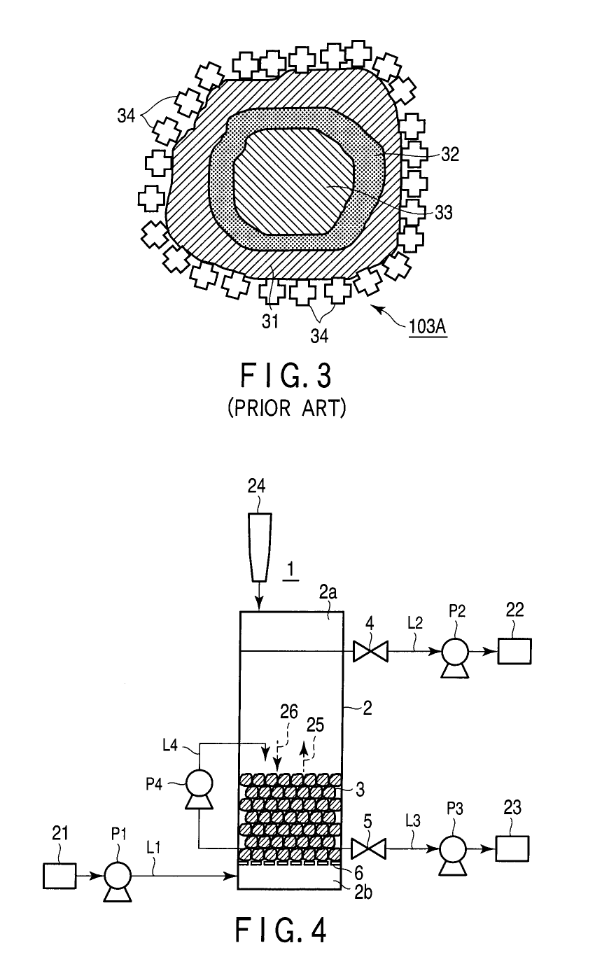

### DETAILED DESCRIPTION OF THE INVENTION

An adsorption apparatus according to the present invention comprises; a reaction tank configured to perform fluid contact reaction between an adsorbent and a resource substance contained in wastewater; a supplying device configured to supply wastewater containing the resource substance to the reaction tank; a charging device configured to charge the adsorbent into the reaction tank; a water discharging device configured to discharge a treated water, obtained by adsorbing the resource substance to the adsorbent, from the reaction tank; a adsorbent discharging device configured to discharge the adsorbent, having the resource substance adsorbed thereto, from the reaction tank; and an adsorbent flow out preventing device configured to prevent flow out of the adsorbent from the reaction tank during fluid contact reaction between the adsorbent and the resource substance contained in the wastewater.

The adsorbent flow out preventing device comprises a change device which changes a flow state of the water in the reaction tank when the wastewater is supplied or when the treated water is discharged.

The apparatus according to the present invention preferably comprises, as such a change device which changes a flow state of the water in the reaction tank, a circulation line and a circulation pump which circulate wastewater in the reaction tank in a direction different from that of the stream of the wastewater supplied to the reaction tank from the supplying device. Alternatively, the change device which changes a flow state of the water in the reaction tank may be a baffle plate which is provided in the reaction tank between a adsorbent layer formed of the adsorbent and the water discharging device, to limit the movement of the adsorbent likely to flow out from the reaction tank along with the stream of the treated water being discharged from the reaction tank. Alternatively, the change device which changes a flow state of the water in the reaction tank may be a filtration membrane which is provided in the reaction tank between a adsorbent layer formed of the adsorbent and the water discharging device, to limit the movement of the adsorbent likely to flow out from the reaction tank along with the stream of the treated water being discharged from the reaction tank.

In this case, the apparatus according to the present invention preferably further comprises a cleaning device to clean the filtration membrane provided in the reaction tank. This is because the ability of the filtration membrane to allow the water to pass through is reduced due to the occurrence of clogging resulting from long-term continuous operation, and therefore it is necessary to regularly clean the filtration membrane by the cleaning device to recover the ability of the filtration membrane to allow water to pass through. As such an apparatus to clean the filtration membrane, the above-described circulation line can be used for backwashing of the filtration membrane.

It is to be noted that wastewater to be treated by the apparatus according to the present invention contains, as the resource substance to be treated, a component such as phosphate anions, boron ions, fluorine ions, or oil. Among them, phosphate anions are preferred. Further, the adsorbent to be used in the present invention is hydrotalcite, silica, alumina, or activated carbon. Among them, the adsorbent is preferred because fine particles of unmixed hydrotalcite can very efficiently adsorb phosphate anions. The unmixed hydrotalcite particles do not include the binder and the core material. Such fine particles of unmixed hydrotalcite are fine particles which have a specific gravity larger than 1 and an average particle size within between 0.1 μm and 20 μm (0.1 μm and 20 μm included).

The reaction tank of the apparatus according to the present invention may be of any one of a fixed-bed type reactor, a fluidized-bed type reactor, and an expanded-bed type reactor, but is particularly preferably of a fluidized-bed type reactor.

Further, in a case where the reaction tank of the apparatus according to the present invention is a form of a fluidized-bed type reactor, the flow rate ratio between an upward-moving stream (water stream 25 shown in FIGS. 4 to 6) and a downward-moving stream (water stream 26 shown in FIGS. 4 to 6) is preferably in the range of from 1:0.1 to 1:1. If the flow rate ratio is less than 1:0.1, it is impossible to effectively change the flow of the upward-moving stream, thereby increasing the amount of the adsorbent that flow outs from the reaction tank. On the other hand, if the flow rate ratio exceeds 1:1, the reaction tank cannot perform its original function, that is, cannot serve as a fluidized-bed reactor, thereby reducing the efficiency of adsorption using the adsorbent.

Hereinbelow, various preferred embodiments of the present invention will be described with reference to the accompanying drawings.

### First Embodiment

A wastewater adsorption apparatus according to a first embodiment of the present invention will be described with reference to FIG. 4.

A wastewater adsorption apparatus 1 according to the first embodiment comprises a wastewater supply line L1, a treated-water discharge line L2, an adsorbent discharge line L3, a circulation line L4, and a reaction tank 2. All of these lines L1 to L4 are communicated with the reaction tank 2. The reaction tank 2 contains a fluidized bed of an adsorbent 3 therein.

A support 6 is provided in a lower portion of the reaction tank 2. A layer of adsorbent 3 is supported on the support 6. A bottom region 2b is formed a bottom of the reaction tank 2 and the support 6.

More specifically, the wastewater supply line L1 including a pump P1 is communicated with the bottom region 2b of the reaction tank 2 to introduce, as wastewater to be treated, a liquid (containing phosphate anions), which is generated by solid-liquid separation of sludge in the process of treating excess sludge, into the reaction tank 2 from a wastewater supply source 21. On the other hand, the treated-water discharge line L2 including a pump P2 and an on-off valve 4 is communicated with an upper region 2a of the reaction tank 2 to discharge treated water from the reaction tank 2 into a treated-water discharger 22.

The treated water is sent to the next process through the treated-water discharger 22. The adsorbent discharge line L3 including a pump P3 and an on-off valve 5 is communicated with the layer of adsorbent 3 provided close to a lower part of the reaction tank 2 to discharge the adsorbent 3 from the reaction tank 2 into an adsorbent discharger 23. The circulation line L4 including a pump P4 is communicated with the reaction tank 2 at a position close to the lower part of the reaction tank 2 and a position close to a middle part of the reaction tank 2. By sending wastewater present close to the lower part of the reaction tank 2 to the middle part of the reaction tank 2 using the circulation line L4, it is possible to create a circulating water stream including a downward-moving stream 26 in the reaction tank 2. It is to be noted that the distance between the fluidized bed of the adsorbent 3 and an upper discharge port being in communication with the treated-water discharge line L2 is sufficiently large so that the adsorbent 3 is less likely to flow out from the reaction tank 2. For example, the distance between the upper end of the fluidized bed of the adsorbent 3 and the upper port of the reaction tank 2 being in communication with the treated-water discharge line L2 can be set to range of 1.5 to 5 m.

In the first embodiment, unmixed hydrotalcite particles having a predetermined particle size (average particle size: range of 0.1 to 20 μm) are used as the adsorbent 3. The unmixed hydrotalcite particles do not include the binder and the core material (eg. zeolite). In the bottom region 2b of the reaction tank 2, a support 6 having a plurality of pores whose pore size is smaller than the particle size of the hydrotalcite particles is provided so that the hydrotalcite particles 3 can be accumulated on the support 6. Therefore, the fluidized bed of the hydrotalcite particles 3 is formed by allowing wastewater present in the bottom region 2b of the reaction tank 2 to flow upwardly through the pores formed in the support 6.

Hereinbelow, the operation of the first embodiment will be described.

During the contact adsorption between wastewater and the adsorbent 3, the adsorbent discharge valve 5 is shut off and the treated-water discharge valve 4 is open, and wastewater is supplied to the bottom region 2b of the reaction tank 2 through the supply line L1. The wastewater is allowed to flow in an upward direction, that is, in a direction represented by a water stream 25 so as to pass through the support 6 and then the layer of the hydrotalcite particles 3. Then, treated water is discharged from the reaction tank 2 through the line L2 including the treated-water discharge valve 4.

During this operation, water present close to the lower region of the reaction tank 2 is cyclically supplied to the middle region of the reaction tank 2 through the circulation line L4 by driving the circulation pump P4. The water supplied to the middle region of the reaction tank 2 creates the downward-moving stream 26 that flows downwardly in the reaction tank 2. The downward-moving stream 26 suppresses the movement of the hydrotalcite particles 3 in the direction of the upward-moving stream 25, thereby enabling the hydrotalcite particles 3 to be retained in the circulation line L4 and in a range between the bottom part and the middle region of the reaction tank 2. This makes it possible to prevent the hydrotalcite particles 3 from escaping from the reaction tank 2.

Phosphate anions 34 contained in the wastewater are adsorbed to the surface of the hydrotalcite particles 3 due to contact with the hydrotalcite particles 3. Spent hydrotalcite particles 3A can be discharged from the reaction tank 2 through the line L3 by opening the adsorbent discharge valve 5, and are then recovered by the adsorbent discharger 23.

Hereinbelow, the effects of the first embodiment will be described.

The apparatus 1 according to the first embodiment of the present invention can be easily operated because the necessity to provide another adsorbent flow out prevention apparatus, such as a baffle plate or a membrane, in the reaction tank 2 can be eliminated by providing the circulation line L4 including the pump P4 outside the reaction tank 2, and therefore the hydrotalcite particles 3 as powdery adsorption can be newly or additionally charged into the reaction tank 2 from an adsorbent charger 24 provided above the reaction tank 2.

Further, the reaction tank 2 can have a simple structure, thereby making it easy to clean the inside of the reaction tank 2.

Further, the flow out of the hydrotalcite particles 3 can be prevented by controlling the pump discharge of the circulation pump P4 in accordance with the particle size of the hydrotalcite particles 3, the amount thereof contained in the reaction tank 2, or the flow rate of wastewater. More specifically, when the hydrotalcite particles 3 have a smaller particle size, or the amount thereof contained in the reaction tank 2 is smaller, or the flow rate of wastewater is larger, the hydrotalcite particles 3 are more likely to flow out from the reaction tank 2. In the first embodiment, the distance between the fluidized bed of the hydrotalcite particles 3 and the opening being in communication with the treated-water discharge line L2 in the direction of the height of the reaction tank 2 is sufficiently large (e.g., 1.5 to 5 m), but there is a case where the hydrotalcite particles 3 flow out from the reaction tank 2 when the flow rate of the upward-moving stream 25 is large. Therefore, in such a case, the flow out of the hydrotalcite particles 3 can be effectively prevented by increasing the flow rate of the circulation pump P4.

A liquid (containing phosphate anions), generated by solid-liquid separation of sludge in the process of treating excess sludge, was prepared as wastewater to be treated and treated by the unit 1 shown in FIG. 4 using hydrotalcite particles having an average particle size of 1 μm as an adsorbent to adsorb phosphate anions contained in the wastewater to the adsorbent. It is to be noted that, in this treatment operation, the flow rate ratio between an upward-moving stream and a downward-moving stream was 1:0.5. As a result, the amount of the adsorbent that flow out from the reaction tank 2 was significantly small.

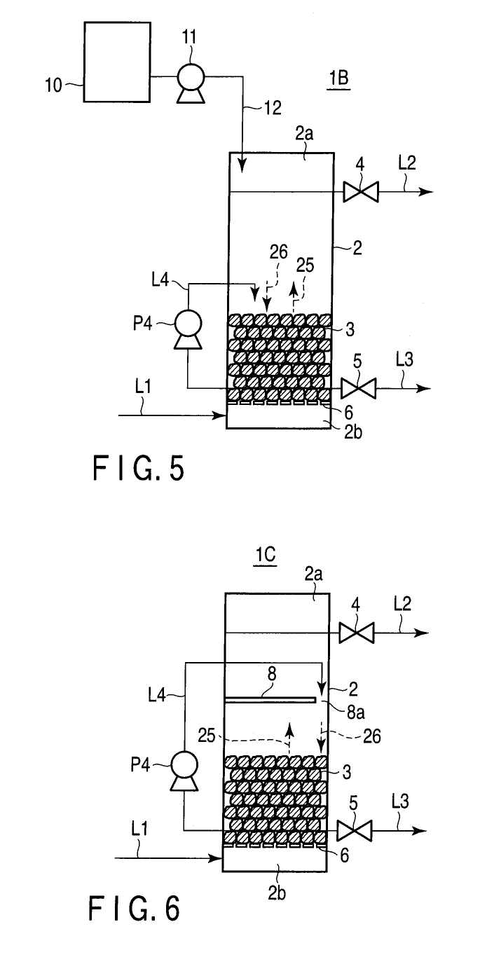

FIG. 5 shows a wastewater adsorption apparatus 1B that is a modification of the first embodiment according to the present invention. The apparatus 1B comprises an adsorbent supply source 10, a pump 11, and an adsorbent supply line 12, which are provided above the reaction tank 2. By driving the pump 11, a slarry adsorbent 3 (not powdery) is supplied from the adsorbent supply source 10 through the line 12 into the reaction tank 2. The apparatus 1B is advantageous in that it can be operated without reducing the efficiency of contact reaction between wastewater and the adsorbent 3 by additionally charging the hydrotalcite particles 3, even when the amount of the hydrotalcite particles 3 contained in the reaction tank 2 is reduced by discharging the spent hydrotalcite particles 3 from the reaction tank 2.

### Second Embodiment

A second embodiment of the present invention will be described with reference to FIG. 6. It is to be noted that descriptions overlapping with the above embodiment will be omitted.

A wastewater adsorption apparatus 1C according to the second embodiment of the present invention comprises a baffle plate 8 provided between the fluidized bed of the adsorbent 3 and the upper discharge port being in communication with the treated-water discharge line L2. The baffle plate 8 includes at least one opening 8a to allow water to pass through. The baffle plate 8 is provided to limit part of the upward-moving stream 25 that flows from the fluidized bed of the adsorbent 3. A discharge port of the circulation line L4 is provided at a position directly above the opening 8a of the baffle plate 8 in order to discharge wastewater, which is present close to the lower part of the reaction tank 2 located on the upstream side of the reaction tank 2, downwardly toward the opening 8a to create the downward-moving stream 26.

In the case of the apparatus 1C according to the second embodiment, since the downward-moving stream 26 is created by a combination of the circulation line L4 including the circulation pump P4 and the baffle plate 8 including the opening 8a, the flow out of the hydrotalcite particles 3 can be more effectively suppressed by the effect of such a downward-moving stream 26, and even when some of the hydrotalcite particles 3 having a relatively small particle size flow upwardly from the fluidized bed, the flow out of these hydrotalcite particles 3 from the reaction tank 2 can be prevented by the baffle plate 8.

The position where the adsorbent discharge line L3 including the valve 5 is connected to the reaction tank 2 is not limited to the lower part of the layer of the hydrotalcite particles 3, and the adsorbent discharge line L3 can be connected to the upper part of the layer of the hydrotalcite particles 3. In this case, spent hydrotalcite particles can be recovered by allowing them to flow toward the upper part of the reaction tank 2, which is advantageous in that the recovery efficiency of them can be improved.

### Third Embodiment

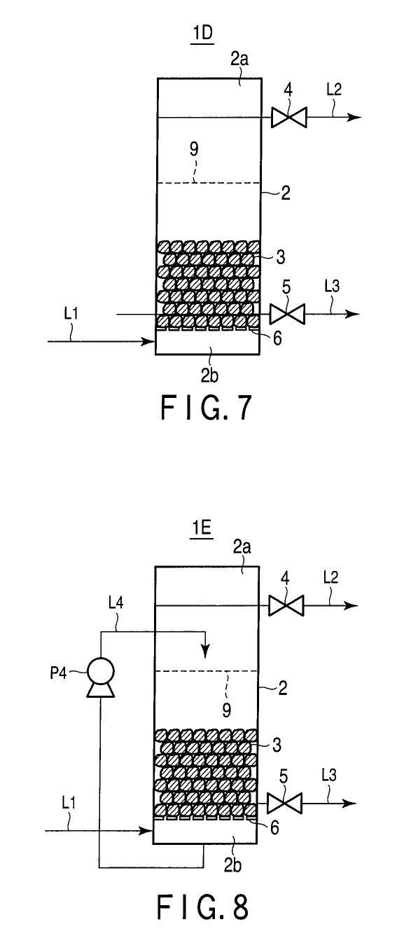

A third embodiment of the present invention will be described with reference to FIG. 7. It is to be noted that descriptions overlapping with the above embodiments will be omitted.

A wastewater adsorption apparatus 1D according to the third embodiment of the present invention comprises a filtration membrane 9 having a plurality of pores with an average pore size of 0.1 μm to allow water to pass through. The filtration membrane 9 is provided between the fluidized bed of the adsorbent 3 and the upper discharge port being in communication with the treated-water discharge line L2.

In the case of the unit 1D according to the third embodiment, even when the hydrotalcite particles 3 flow from the fluidized bed toward the upper region 2a of the reaction tank 2, they cannot pass through the filtration membrane 9 at all. Therefore, the hydrotalcite particles 3 are retained under the filtration membrane 9 so that only clarified wastewater is discharged as treated water through the discharge line L2 including the valve 4.

As described above, the unit 1D according to the third embodiment comprises the filtration membrane 9 having pores with an average pore size of 0.1 μm, and therefore it is possible to prevent the flow out of the hydrotalcite particles 3.

A modification of the third embodiment can use another filtration membrane having a pore size of 0.1 to 20 μm. In this case, there is an advantage that the clogging of the surface of the membrane can be reduced when the hydrotalcite particles 3 have a relatively large average particle size, for example, 10 μm, and the average pore size of the filtration membrane is 5 μm.

### Fourth Embodiment

A fourth embodiment of the present invention will be described with reference to FIG. 8. It is to be noted that descriptions overlapping with the above embodiments will be omitted.

A wastewater adsorption apparatus 1E according to the fourth embodiment uses the circulation line L4 including the circulation pump P4 and the filtration membrane 9 together.

In this case, even when the clogging of the filtration membrane 9 occurs, the filtration membrane 9 can be cleaned without stopping contact adsorption. More specifically, substances clogging the surface of the filtration membrane 9 can be removed simply by operating the circulation pump P4.

The wastewater adsorption apparatus according to the present invention makes it possible to prevent the flow out of the adsorbent from the reaction tank without reducing the purity of a recovered resource substance.

What is claimed is:

1. An adsorption apparatus for wastewater, comprising:
a reaction tank configured to allow adsorption of a resource substance contained in wastewater on an adsorbent to be carried out therein;
a supplying device configured to supply wastewater containing the resource substance to the reaction tank;
a charging device configured to charge the adsorbent into the reaction tank;
a water discharging device configured to discharge a treated water, obtained after the wastewater is removed of the resource substance by the adsorption, from the reaction tank;
a adsorbent discharging device configured to discharge the adsorbent having the resource substance adsorbed thereon, from the reaction tank; and
an adsorbent flow out preventing device configured to prevent flow out of the adsorbent from the reaction tank during the adsorption.

2. The apparatus according to claim 1, wherein the adsorbent flow out preventing device comprises a change device which changes a flow state of the water in the reaction tank when the wastewater is supplied or when the treated water is discharged.

3. The apparatus according to claim 2, wherein the change device which changes a flow state of the water in the reaction tank is a combination of a circulation line and a circulation pump which circulate the wastewater in the reaction tank in a direction different from that of a stream of the wastewater supplied to the reaction tank from the supplying device.

4. The apparatus according to claim 2, wherein the change device which changes a flow state of the water in the reaction tank is a baffle plate provided in the reaction tank between an adsorbent layer formed of the adsorbent and the water discharging device, to limit movement of the adsorbent likely to flow out from the reaction tank along with a stream of the treated water being discharged from the reaction tank.

5. The apparatus according to claim 2, wherein the change device which changes a flow state of the water in the reaction tank is a filtration membrane provided in the reaction tank between an adsorbent layer formed of the adsorbent and the water discharging device, to limit movement of the adsorbent likely to flow out from the reaction tank along with a stream of the treated water being discharged from the reaction tank.

6. The apparatus according to claim 5, further comprising a cleaning device which cleans the filtration membrane.

7. The apparatus according to claim 1, wherein the wastewater contains phosphate anions as the resource substance and the adsorbent is composed of fine particles of unmixed hydrotalcite.
